(19) United States
(12) Patent Application Publication
(10) Pub. No.: US 2010/0050788 A1
(43) Pub. Date: Mar. 4, 2010

(54) Nanoscale Force Transducer

(75) Inventor: Youngtack Shim, Seoul (KR)

Correspondence Address: OMIKRON IP LAW GROUP, 16325 Boones Ferry Rd., SUITE 204, LAKE OSWEGO, OR, 97035, US

(73) Assignee: SEOUL NATIONAL UNIVERSITY INDUSTRY FOUNDATION, Seoul (KR)

(21) Appl. No.: 12/198,663

(22) Filed: Aug. 26, 2008

(51) Int. Cl. G01L 1/22

(52) U.S. Cl. 73/862.629; 702/41; 977/956; 977/773

(57) ABSTRACT

Nanoscale measurement of force, torque, and acceleration are provided. In one embodiment, a measurement apparatus includes a first plurality of nanoparticles coupled to a first substrate separated from a second plurality of nanoparticles coupled to a second substrate by a pillar disposed between the first substrate and the second substrate.

### TECHNICAL FIELD

The present disclosure relates generally to the measurement of system parameters and, more specifically, to the nanoscale measurement of force, torque and acceleration.

### BACKGROUND

Nanotechnology is an important field of endeavor that provides materials and devices in nanoscale that may be used in a wide variety of applications. In the implementation of nanoscale materials and devices, it may be useful to sense and measure various parameters, such as force, torque and acceleration. Further, it may be advantageous to sense and measure parameters with sensitivity such that small magnitudes may be measurable.

### BRIEF DESCRIPTION OF THE DRAWINGS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the figures, may be arranged, substituted, combined, and designed in a wide variety of different configurations, all of which are explicitly contemplated and made part of this disclosure.

FIG. 1 is a cross-sectional side view of an illustrative embodiment of a nanoscale measurement apparatus according to an embodiment.

FIG. 2 is a diagram of an illustrative embodiment of a nanoscale measurement system.

FIG. 3 is an enlarged cross-sectional side view of an illustrative embodiment of a nanoscale measurement apparatus in a rest state.

FIG. 4 is an enlarged cross-sectional side view of an illustrative embodiment of a nanoscale measurement apparatus with a force applied.

FIG. 5 is an enlarged cross-sectional side view of an illustrative embodiment of a nanoscale measurement apparatus with a force applied.

FIG. 6 is a cross-sectional side view of an illustrative embodiment of a nanoscale measurement system.

FIG. 7 is a cross-sectional side view of an illustrative embodiment of a nanoscale measurement apparatus mounted in a package.

FIG. 8 is a diagram of an illustrative embodiment of a method.

FIG. 9 is a diagram of an illustrative embodiment of a method.

FIG. 10 is a diagram of an illustrative embodiment of a method.

### DETAILED DESCRIPTION

In the following description, various embodiments will be disclosed. However, it will be apparent to those skilled in the art that the embodiments may be practiced with all or only some of the disclosed subject matter. For purposes of explanation, specific numbers and/or configurations are set forth in order to provide a thorough understanding of the embodiments. However, it will also be apparent to one skilled in the art that the embodiments may be practiced without one or more of the specific details, or with other approaches and/or components. In other instances, well-known structures and/or operations are not shown or described in detail to avoid obscuring the embodiments. Furthermore, it is understood that the embodiments shown in the figures are illustrative representations and are not necessarily drawn to scale.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

References throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner. Various operations may be described as multiple discrete steps in turn, in a manner that is most helpful in understanding the claimed subject matter. However, the order of description should not be construed as to imply that these operations are necessarily order dependent.

This disclosure is drawn, inter alia, to nanoscale measurement devices and apparatuses, methods for measuring nanoscale forces and torques, and related nanoscale systems. The nanoscale measurement device may be considered a force transducer, a torque transducer, or an accelerometer.

In an embodiment, a nanoscale measurement device may include a first plurality of nanoparticles coupled to a substrate surface by optional couplers. The device may also include a second plurality of nanoparticles coupled to a second substrate surface by optional couplers. The first plurality of nanoparticles may be spaced such that they electrically contact each other or such that they have small gaps that may be tunneled by electrons. In either case, electrical continuity across the first plurality of nanoparticles may be provided. The second plurality of nanoparticles may be similarly situated to provide electrical continuity across the second plurality of nanoparticles. The first and second pluralities of nanoparticles may face each other and, in the rest state of the device, be held apart by pillars disposed between the surfaces of the first and second substrates. Electrical contact to the first and second pluralities of nanoparticles may be made by electrodes, such that one or more electrodes may be incorporated to provide an electrical circuit along each of the first and second pluralities of nanoparticles. In one example, three electrodes may be used with one electrode contacting the first plurality of nanoparticles, a second electrode contacting the second plurality of nanoparticles, and a third electrode contacting the first and second plurality of nanoparticles. In another example, four electrodes may be used with two electrodes contacting the first plurality of nanoparticles at opposite ends of the device and two other electrodes contacting the second plurality of nanoparticles at the opposite ends of the device. The electrodes may be coupled to a sensing device that may provide an electrical voltage or current in order to measure characteristic resistances of the nanoscale measurement device. Accordingly, the device may monitor changes in electrical properties of at least one of the first and second pluralities of the nanoparticles, changes in electrical interactions between the first and second pluralities of the nanoparticles, or the like.

In operation, a force may be applied to a surface of one or both of the substrates and the device may begin to deform such that the substrates may bow. The sensing device may be able to detect the deformation by sensing a change in the measured electrical resistances. In an embodiment, the change in resistance may be due to changes in the positions of the nanoparticles as compared to the rest state in one or both of the first and second pluralities of nanoparticles. For example, the first or second plurality of nanoparticles may tend to splay apart under the applied force or the first or second plurality of nanoparticles may tend to compact. Those changes may cause a change in the resistances sensed by the sensing device, which may be correlated to a measurement of force, torque or acceleration. In another example, the device may be configured such that some of the first plurality of nanoparticles contact some of the second plurality of nanoparticles upon the application of a force. The number of contacting particles may depend on the amount of force applied. The contact between the particles may cause a change in the characteristic resistances that may be sensed and correlated to a force, torque or acceleration measurement.

In another embodiment, a light emitter and a detector may be provided. The light source may irradiate the device and the detector may receive resultant light rays. The light rays may be transmitted through the device or the light rays may be reflected off the device. In either event, the resultant light rays may be monitored for, for example, a polarization change, an intensity change or a diffraction pattern. The monitored parameter may relate to a change in an optical property of the device due to an above described deformation of the device, which may be correlated to a force, torque or acceleration measurement. In some examples, the light source and the detector may be used without the electrodes and electrical sensor, and in other examples, they may be used with the electrodes and a sensor.

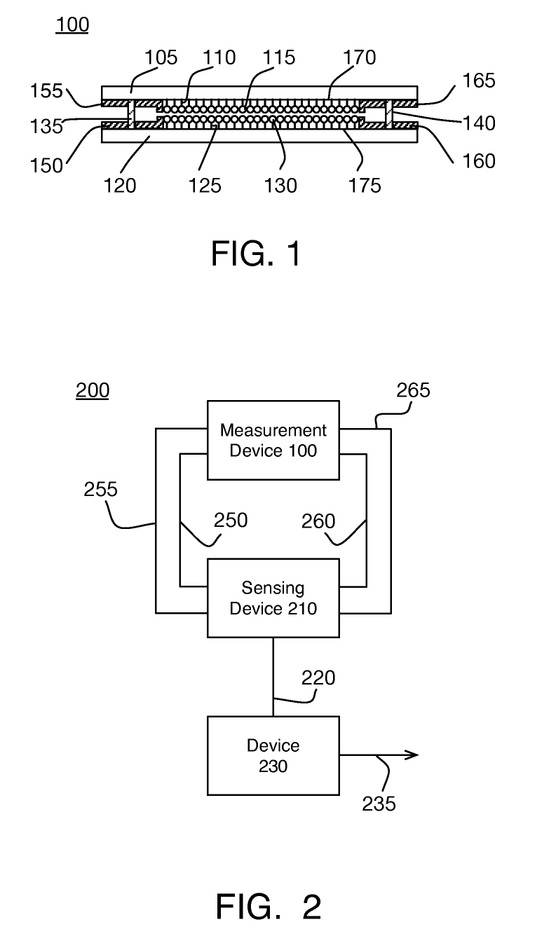

Turning now to FIG. 1, an embodiment will be described. As illustrated in FIG. 1, a measurement device 100 may include a substrate 105, couplers 110, nanoparticles 115, a substrate 120, couplers 125, nanoparticles 130, pillars 135, 140, and electrodes 150, 155, 160, 165. Measurement device 100 may measure force, torque or acceleration on a nanoscale and may therefore be considered a nanoscale measurement apparatus or device. As shown, nanoparticles 115 and nanoparticles 130 may be held apart at a preset distance in the rest state (with little or no force applied) of measurement device 100 such that they may be mechanically and electrically isolated from each other.

Further, nanoparticles 115 and nanoparticles 130 may have electrical or optical characteristics that may be probed via the electrodes. When a force is applied to measurement device 100, the configuration of the nanoparticles may change such that the electrical or optical characteristics may change. Those changes may be correlated to determine a measured force, for example, of the force applied to the device. Since measurement device 100 may include two or more layers of nanoparticles, it may be considered a multilayered nanoparticle device. Although illustrated in a cross-section or side view for ease of understanding, measurement device 100 may be an enclosed device including a sealant around the edge of the device and between substrate 120 and substrate 105.

Referring now to FIG. 2, measurement device 100 may be electrically coupled to a sensing device 210 by connectors 250, 255, 260, 265 as a part of a system 200. Connector 250 may be electrically coupled to electrode 150, connector 255 may be electrically coupled to electrode 155, connector 260 may be electrically coupled to electrode 160, and connector 265 may be electrically coupled to electrode 165. Connectors 250, 255, 260, 265 may be provided in a variety of configurations, such as, but not limited to, discrete wires or conductive traces on a substrate or circuit board. Sensing device 210 may be considered a part of a nanoscale measurement device or it may be considered separate from the measurement device.

Sensing device 210 may electrically probe measurement device 100 using the connectors and electrodes. In one example, sensing device 210 may include a voltage source and a current measuring device. In another example, sensing device 210 may include a current source and a voltage measuring device. Sensing device 210 may include multiple voltage sources and/or current sources. Sensing device 210 may also include a processor, a memory, and related circuitry that may provide control over a sensing pattern and memory for data storage. Using the provided voltage and measured current (or provided current and measured voltage), a characteristic resistance of the measurement device may be determined. As discussed, connectors 255, 265 may couple to one set of nanoparticles while connectors 250, 260 may couple to another set of nanoparticles. Connectors 250, 255 may be coupled to one side of a voltage source and connectors 260, 265 coupled to another side of the voltage source, such that a parallel circuit may be provided. By measuring the resistance of the parallel circuit a sensitive measurement of a force on the device may be obtained.

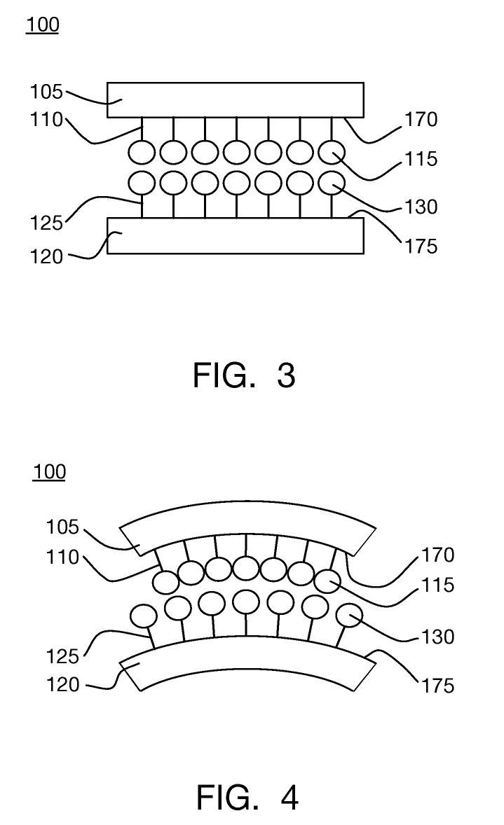

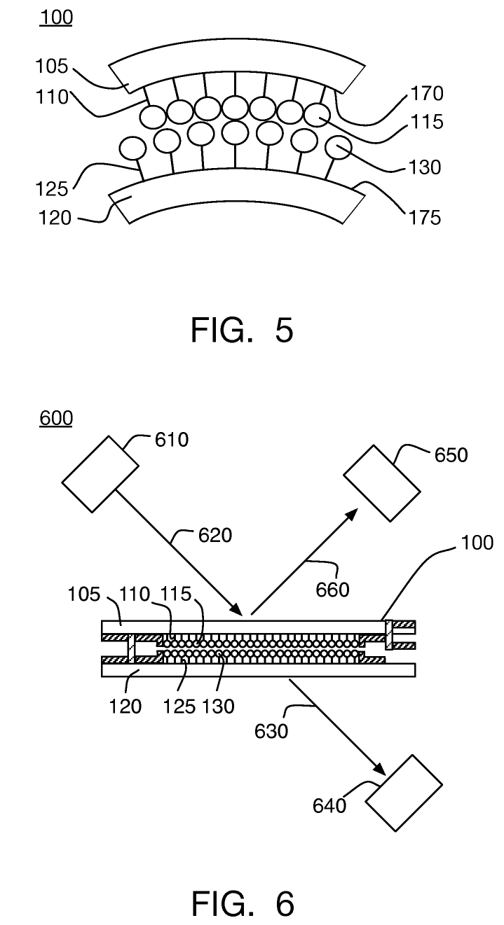

With reference to FIGS. 3-5, operations of the measurement device according to various embodiments will be described. FIG. 3 illustrates an enlarged view of measurement device 100 in its rest state. FIG. 4 illustrates an embodiment of the measurement device when a torque is applied, and FIG. 5 illustrates another embodiment of the measurement device when a torque is applied. When the applied force is removed, the measurement device may return to substantially the same configuration as before the force was applied. In the embodiments illustrated in FIG. 4 and FIG. 5, a downward force may be applied to one end of measurement device 100 and the other end of measurement device 100 may be anchored or secured. As shown in FIG. 4 and FIG. 5, the applied force may cause deformation that may cause nanoparticles 115 to tend to compact while nanoparticles 130 may tend to splay apart. The device deformation may include a bowing of substrate 105 and substrate 120. A greater magnitude of applied force may cause more compacting and splaying of the nanoparticles.

Such changes in orientation may cause change in the resistances of the device. For example, a closed parallel circuit using connectors 250, 255 coupled to one end of a voltage source and connectors 260, 265 (please refer to FIG. 2) coupled to an opposite end of the voltage source may be used with a current detector to determine a characteristic resistance of the device. In another example, the resistance of a circuit using connector 255 and connector 265 may be sensed. Such a resistance may decrease in the example of FIG. 4 due to nanoparticles 115 being more densely packed. The resistance of a circuit using connector 250 and connector 260 may also be sensed. Such a resistance may increase in the example of FIG. 4 due to nanoparticles 130 being less densely packed. As discussed above, a variety of circuits may be used in the sensing process to gain information, such as electrical characteristics, related to the deformation of the measurement device. The electrical characteristics may be used to provide force, torque or acceleration measurements.

As shown in FIG. 5, in some embodiments, the deformation of the measurement device may cause some of nanoparticles 115 to contact some of nanoparticles 130. In FIG. 5, one of nanoparticles 115 is shown in contact with one of nanoparticles 130 for ease of illustration. In practice, several or many of the adjacent nanoparticles may contact each other. Some of nanoparticles 115 may contact some of nanoparticles 130 because, with a force applied on one end of the measurement device, the two substrates may tend to bend or bow about the same center of rotation with a same or similar radius of curvature. With the pillars mechanically coupling the substrates, substrate 105 may bend while substantially maintaining the same arcuate length between the pillars, which may cause substrate 105 to flatten and move downward. Such downward movement may cause some of nanoparticles 115 to contact some of nanoparticles 130, as shown. Such downward movement may also result when the pillars do not bend, but may angularly displace from their rest state. More nanoparticles may make contact as the magnitude of the applied force increases. The number of contacting nanoparticles may change the electrical characteristics of the device, and the sensing device may sense a variety of characteristic resistances in the device, as discussed, which may similarly be correlated to force, torque or acceleration measurements.

As discussed, electrical conductivity between the nanoparticles may be provided by electron tunneling across gaps or by the nanoparticles being densely enough spaced to provide direct electrical connection. Although FIG. 3, FIG. 4 and FIG. 5 may show gaps between the nanoparticles that are closed or opened under the application of a force, no such gaps may be required for the function of the measurement device. Some examples may include gaps and some may not.

Referring again to FIG. 1 and FIG. 2, other embodiments will be described. As discussed, FIG. 1 illustrates measurement device 100, substrate 105, couplers 110, nanoparticles 115, substrate 120, couplers 125, nanoparticles 130, pillars 135, 140, and electrodes 150, 155, 160, 165. Substrates 105, 120 may include a wide variety of rigid or semirigid materials including, but not limited to, inorganic materials, silicon, silicon dioxide, ceramics, quartz, organic materials, polymers, or plastics. In general, the substrates may be any material that may deform under the forces or torques to be measured at the substrate thicknesses provided. In some examples, substrate 105 and substrate 120 may be provided as laminate structures including a plurality of materials stacked in layers. Substrates 105, 120 may include insulating materials such that the substrates do not provide a conduction path. Substrate 105 and substrate 120 may be the same material or substrate 105 and substrate 120 may be different materials. In general, the materials used for substrates 105, 120 may be chosen based on parameters of the required application such as, but not limited to, the ambient the materials may be subjected to, the forces to be measured and other material choices within the transducer. In some embodiments, at least one of substrates 105, 120 or both may be made at least partially transparent such that light rays may be irradiated into the nanoparticles 115 or nanoparticles 130 and the light rays may be reflected, refracted, or diffracted therefrom. Based at least in part on a characteristic of the resultant light rays, the device may measure force, torque or acceleration. In an embodiment, a light source and a light detector may be provided, as will be further discussed below.

Nanoparticles 115 may be coupled to surface 170 of substrate 105 by optional couplers 110, and nanoparticles 130 may be coupled to surface 175 of substrate 120 by optional couplers 125. Alternatively, nanoparticles 115, nanoparticles 130, or both may be directly mounted to their respective substrates. Nanoparticles 115 and nanoparticles 130 may be any suitable size. In some examples, they may have diameters in the range of approximately 100 to 2,500 nm. In other examples, they may have diameters in the range of approximately 1 to 100 nm. Nanoparticles 115, 130 may include a variety of conductive materials including, but not limited to, copper, silver, gold, nickel, palladium, platinum, tin, lead, aluminum, and alloys thereof. Different materials may be used among nanoparticles 115 or nanoparticles 130 such that the nanoparticles are not necessarily uniform across their entirety. For example, materials of different conductivities may be used across the device in some applications. Nanoparticles 115 and nanoparticles 130 may include uniform conductive materials or they may include nonconductive nanoparticles with conductive coatings. Nanoparticles 115 and nanoparticles 130 may include the same materials or they may include different materials.

Nanoparticles 115 may be configured to provide electrical continuity among nanoparticles 115, and nanoparticles 130 may be similarly configured to provide electrical continuity among nanoparticles 130. In some examples, the electrical continuity may be provided by the nanoparticles being spaced densely enough to provide direct electrical contact. In other examples, there may be gaps between the nanoparticles that may be quantum mechanically tunneled by electrons such that electrical continuity may be provided. Nanoparticles 115 and nanoparticles 130 may be configured as a conductive tightly packed array or mesh of nanoparticles. Nanoparticles 115, 130 may be evenly or nearly evenly spaced throughout the device as one mesh. Alternatively, the nanoparticles may be spaced at different pitches at different locations of the device. Further, two or more conductive meshes of nanoparticles may be used. The multiple nanoparticle meshes may be provided in series or parallel electrically.

Optional couplers 110, 125 may include a variety of rigid, semirigid or flexible materials, such as, but not limited to, long chain molecules, molecular assemblies of high aspect ratios, nanotubes, lipids, DNA, RNA, and proteins. Couplers 110, 125 may include insulating materials so as not to provide a conduction path. In an embodiment, couplers 110, 125 may be at least partially electrically conductive and couplers 110, 125 may form an additional path or additional paths for electrons, such that such couplers 110, 125 may increase the current when a torque is applied, thereby enhancing the sensitivity of device 100. Couplers 110 may include the same material as substrate 105 and/or couplers 125 may include the same material as substrate 120, such as the sample materials listed above. Couplers 110 may be of approximately the same length as couplers 125 or their lengths may be different. For example, couplers 110 may be longer than couplers 125. Couplers 110 and couplers 125 may be of any suitable length, such as, but not limited to, approximately 10 to 2,000 nm. A single coupler may be included for each nanoparticle or multiple couplers, such as, but not limited to, 2 to 5 couplers, may be provided for each nanoparticle.

Further, couplers 110 may have approximately the same lengths throughout the device or their lengths may vary, such that in side-view profile they have, for example, a sloped shape. That is, on one end of the device, couplers 110 may be shorter or longer than on another end of the device. Other profile shapes may be used, such as, for example, curved shapes. Typically, couplers 110 and couplers 125 may have approximately the same profile shapes such that distance between immediately adjacent nanoparticles 115 and nanoparticles 130 may be approximately constant throughout the device. For example, in FIG. 1, both couplers 110 and couplers 125 form similar profile shapes that may be relatively flat across the device such that the distance between nanoparticles 115 and nanoparticles 130 may be approximately constant across the device. However, the distance between adjacent nanoparticle may also be varied across the device in some applications.

As shown, pillars 135, 140 may be disposed between surface 170 and surface 175 such that nanoparticles 115 and nanoparticles 130 may be separated by a distance. Pillars 135, 140 may be partially elastic such that they compress to a shorter profile when the measurement device is deformed or they may be rigid such that they maintain their shape when the device is deformed. In an example, pillars 135, 140 may be rigid such that pillars 135, 140 may be displaced angularly in response to a force or torque and nanoparticles 115, 130 may move closer to each other.

Pillars 135, 140 may take on a variety of configurations. As in the illustrated example, pillars 135, 140 may be provided outside or near the periphery of the nanoparticles. In other examples, an additional pillar or pillars may be provided among the nanoparticles, such as at or near the center of the device. In another example, a pillar or several pillars may be provided among the nanoparticles without pillars being provided outside or near the periphery of the device.

The pillars may include a variety of materials including, but not limited to, long chain molecules, crooked long chain molecules, molecular assemblies of high aspect ratios, nanotubes, lipids, DNA, RNA, and proteins. In some examples, the pillars may include the same material as the substrate materials, as listed above. The pillar materials may maintain the integrity of the device upon repeated applications of force on the device. Pillar 135 may be the same material as pillar 140 or they may be different materials. Further, the pillars may be fixedly coupled to one of the substrates or both substrates. For example, pillar 135 may be fixedly connected to surface 170 of substrate 105 and may be butted against surface 175 of substrate 120. Alternatively, pillar 135 may be fixedly connected to both surface 170 and surface 175.

As shown, nanoparticles 115 may be contacted at one end of the device by electrode 155 and at another end of the device by electrode 165. Similarly, nanoparticles 130 may be contacted at one end of the device by electrode 150 and at another end of the device by electrode 160. Electrodes 150, 155, 160, 165 may include a variety of conductive materials including, but not limited to copper, silver, gold, nickel, palladium, platinum, tin, lead, aluminum, tungsten, alloys of those materials, or carbon nanowires. Electrodes 150, 155, 160, 165 may include the same materials or they may include different materials. Electrodes 150, 155, 160, 165 may provide electrical contact to the nanoparticles and allow probing and measurement of their electrical characteristics. Since the measurement device and/or related circuitry may convert an applied force, torque or acceleration to an electrical characteristic or signal, the measurement device may be considered a force transducer, a torque transducer, or an accelerometer.

Now with reference to FIG. 2, which illustrates measurement device 100 may be electrically coupled to sensing device 210 by connectors 250, 255, 260, 265 as a part of a system 200, other embodiments will be described. The provided connectors may be used in a wide variety of ways to monitor the measurement device by operation of sensing device 210. For example, a resistance using connector 250 and connector 265 may be determined that may be related to a closed circuit running through one end of nanoparticles 130 to an opposite end of nanoparticles 115. In other examples, resistances using circuits with the following connectors being measured: connector 255 and connector 260; connector 255 and connector 265; or connector 250 and connector 260. By monitoring different electrical characteristics of the device, such as, but not limited to, intralayer and interlayer nanoparticle resistances, and relating them to the device configuration and force applied, sensitive measurements of an applied force, torque or acceleration may be made.

As illustrated, four connectors may be provided. In other embodiments, fewer connectors and related electrodes or more connectors and related electrodes may be used. For example, two connectors and electrodes may be used. In other examples, more connectors and electrodes may be used that correspond to multiple nanoparticle meshes or that correspond to a variety of locations on the nanoparticle arrays. By configuring the connectors and electrodes and by monitoring different available paths, a wide variety of characteristic data may be used to monitor the force on measurement device 100.

Sensing device 210 may output raw electrical data or sensing device 210 may output converted measurement data that may relate to a force, torque or acceleration applied on the measurement device. The converted data may be obtained by correlation using the optional processor and memory of the sensing device. For example, the processor may calculate force, torque or acceleration measurement data using conversion parameters stored in the memory or the processor may use the memory to look up the force, torque or acceleration measurement data based on the measured electrical parameters.

Referring again to FIG. 2, a connector 220 to a device 230 may be provided. Further, an output connection 235 may be provided from device 230. In general, device 230 may be any of a wide variety of devices that may control sensing device 210 and/or utilize output from sensing device 210. Device 230 may include a processor, a memory, input/output devices, display devices, and related circuitry. Device 230 may be provided as a computer or workstation. In some examples, measurement device 100 and sensing device 210 may be provided at a board level and may input/output to device 230 by a pin connection.

As discussed, sensing device 210 may provide raw electrical data or a raw electrical signal to device 230. Device 230 may use the raw data and may correlate it to determine a force, torque or acceleration measurement. Device 230 may use the correlated force or torque data in a variety of ways, such as, but not limited to, as a process or system monitor, as feedback to a system, or as a control parameter. Device 230 may provide output over output connection 235 to other devices, databases, or equipment.

Referring now to FIG. 6, another embodiment will be described. As shown, a measurement system 600 may include measurement device 100, a light source 610, an optional detector 640, and an optional detector 650. Measurement device 100 may include any suitable materials or configurations as described above.

In various embodiments, light source 610 may irradiate the device with light rays 620. The light rays may pass through the device and/or reflect off a part or parts of the device. In an embodiment, detector 640 may be provided to detect resultant light rays 630 that may have passed through the device. In such an embodiment, substrates 105, 120 may be at least partially transparent and they may substantially transmit light at the wavelength provided. Detector 640 may detect a parameter of the resultant light rays such as, but not limited to, a polarization change, an optical intensity change, a diffraction pattern, or the like. The optical parameter change may relate to a deformation of the device, splaying of the nanoparticles, compacting of the nanoparticles, or an interaction between the nanoparticles, as described above. Such a change may be correlated to a measurement such as a force, a torque or an acceleration. In an example, the light source and the detector may be provided at an angle with respect to a substrate surface of the device. In another example, light source 610 and detector 640 may be substantially aligned opposite the measurement device.

In another embodiment, detector 650 may be provided to detect resultant light rays 660 that may have reflected off a part of the device. In various examples, the resultant light rays may have reflected off nanoparticles 115, nanoparticles 130, couplers 110, couplers 125, or a combination thereof. In such embodiments, substrate 105 may be at least partially transparent, while substrate 120 may be transparent or opaque. As described with respect to detector 640, detector 650 may detect a parameter of the resultant light rays such as, but not limited to, a polarization change, an optical intensity change, a diffraction pattern, or the like due to a deformation of the device, and may correlate the parameter change to a measurement such as a force, a torque or an acceleration based at least in part on the optical characteristic change. Light source 610 and detector 650 may be provided in any orientation such that light rays 620 and resultant light rays 660 may reflect off the device and be captured by the detector.

In another embodiment, light source 610 may be positioned at one end of the device, and may provide light rays along an axis of the device that may be substantially along the planes of nanoparticles 115, 130. A detector may be positioned at an opposite end of the device to gather the resultant light rays and detect a parameter such as, but not limited to, a polarization change, an optical intensity change, a diffraction pattern, or the like. As discussed, the optical parameter change may correspond to a deformation of the device, and may be correlated to a measurement such as a force, a torque or an acceleration.

In various examples, a single light source may be used. In other examples, multiple light sources may be used. Similarly, one or more detectors may be used in various applications. Also, the light sources and detectors may be used in combination with the described electrodes, sensing device, other devices, and related electrical characteristics measurements or they may be used without the electrodes and related devices. In some embodiments, the illustrated electrodes may not be provided. Further, light source 610 may provide any suitable range of wavelength of light based at least in part on the materials chosen for the components of the device. The described detectors may provide raw data, raw electrical signals, or correlated measurements to another device, which may determine a correlated measurement. In some examples, the detector may include a processor and a memory that may be operable to determine correlated measurement, such as, for example, by using a look up table or calculation using known parameters. The detector may also provide output to other devices as, for example, a process or system monitor, as feedback to a system, or as a control parameter. In an example, the detector may provide an output to sensing device 210 or device 230 (please refer to FIG. 2).

As discussed, a force may be applied at or near an end of the measurement device while the other end of the device, or the center of the device, may be secured to another substrate or mounting platform or support. The force applied and the length of the lever arm over which the force is applied may define a torque that may be acting on the device. The torque may cause a deformation of the device which may change the orientation of the nanoparticles and may cause a change in the electrical characteristics of the device that may be sensed and correlated to a torque measurement.

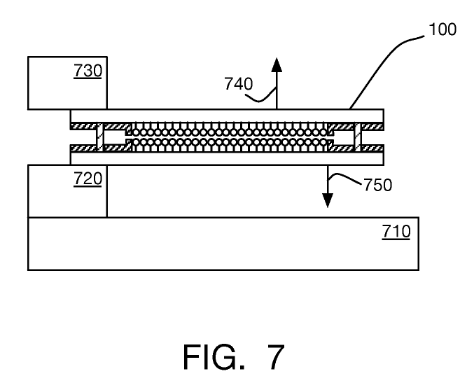

Referring now to FIG. 7, an embodiment showing measurement device 100 mounted in a package is illustrated. In the example shown, measurement device 100 may be secured to a support 720 and a support 730, and may be subject to a force 740 and/or force 750. Support 720 and/or support 730 may be mounted on a substrate 710. As illustrated, measurement device 100 may be secured by both sides, or substrates, and at one end of the device. Also as illustrated, supports 720, 730 may extend at least partially toward a centerline of the device. In other examples, only one of support 720 or support 730 may be used or the supports may be mounted only at the very edge of the device. Further, although edge mounted supports are illustrated, a support or multiple supports at or near the centerline of the device may be used. Any support structure or configuration may be used that may allow measurement device 100 to bow or bend in response to force 740 or force 750. Additionally, although a horizontal arrangement is shown, measurement device 100 may be mounted at any angle relative to substrate 710, such as vertically.

Force 740 and force 750 may be exerted on measurement device 100 in any suitable manner. For example, another object may push against or pull on the device. In other examples, measurement device 100 may be in a fluid and the fluid may exert a force as it may flow around the device or as it may change pressure in the fluid. In other examples, measurement device 100 may be bombarded by particles or particulate. In other examples, the top substrate, the bottom substrate, or both may couple by an external coupler to an object which may translate, rotate, pivot or otherwise move with respect to device 100. In an example, device 100 may be arranged to bend regardless of characteristics of the movement of the object (e.g., a linear or angular movement) based on an arrangement of coupling between device 100 and the object, thereby assessing the movement characteristics of the object by the force, torque or acceleration measured by the device. Further, although forces and torques have been discussed, measurement device 100 may also be used to measure linear or angular acceleration by measuring a temporal change in the force or torque measured. Therefore, measurement device 100 may also be considered an accelerometer.

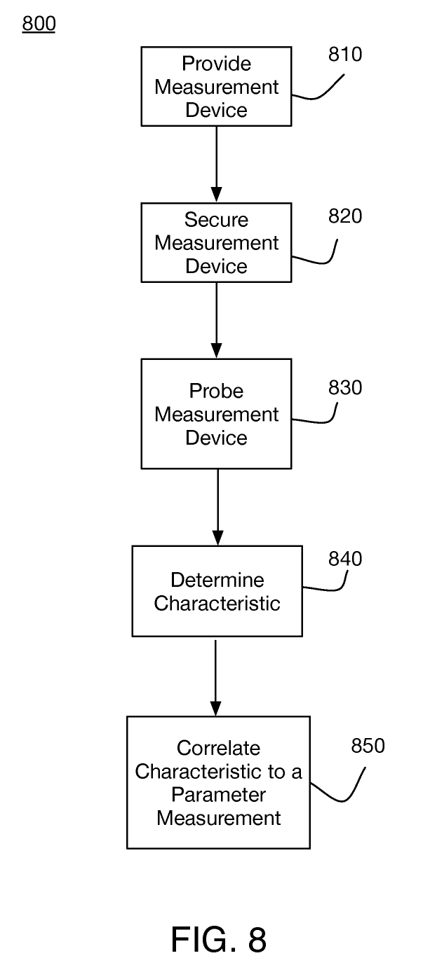

Referring now to FIG. 8, a method 800 according to an embodiment is illustrated. Method 800 may provide a nanoscale measurement parameter of, for example, torque, force or acceleration. At block 810, a measurement device may be provided. Any measurement device as discussed herein may be provided. At block 820, the measurement device may be secured. The measurement device may be secured in any manner, for example, as shown in FIG. 7 or in the other manners as discussed above. At block 830, the measurement device may be probed by a sensing device as discussed above. In various embodiments, the device may be electrically probed, optically probed, or both. At block 840, an electrical or optical characteristic may be determined. In an embodiment, the electrical characteristic may include a resistance. In other embodiments, other electrical characteristics, such as those discussed above, may be determined. In some embodiments, the optical characteristic may be, for example, a polarization change, an intensity change or a diffraction pattern. At block 850, a parameter measurement, such as, but not limited to, a measurement force, torque or acceleration data may be determined, for example, by correlation with a look up data or a conversion calculation, as discussed. In various embodiments, the correlation may be performed by a sensing device, a detector, or another device as described herein. The measurement may be provided to various systems and may be used in a variety of ways, such as, but not limited to, as a process or system monitor, as feedback to a system, or as a control parameter.

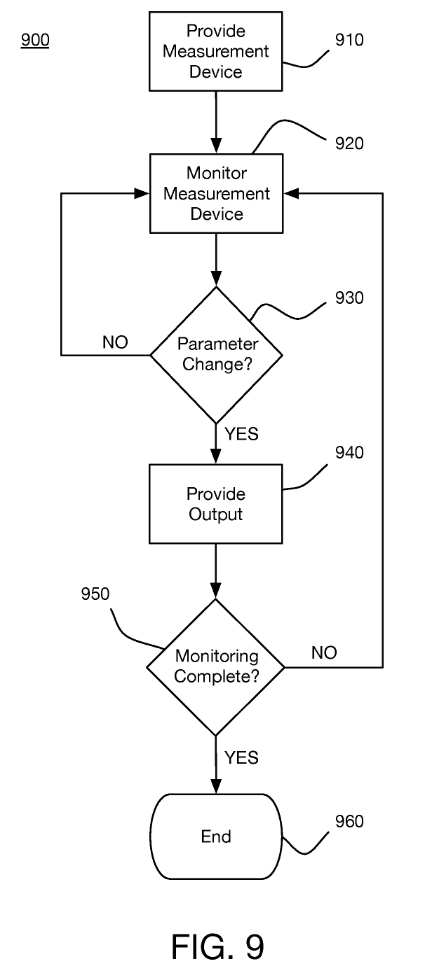

Referring now to FIG. 9, a method 900 according to an embodiment is illustrated. Method 900 may provide for continuous or intermittent monitoring of a force, torque or acceleration at nanoscale and continuous or intermittent output of the measured parameters. At block 910, a measurement device may be provided. Any measurement device as discussed herein may be provided. At block 920, the measurement device may be monitored, for example using electrical probing by a sensing device or optical probing by a light source and a detector, as discussed above. At block 930, an output, such as, but not limited to, a raw electrical signal, raw data, or measurement force, torque or acceleration data may be provided. At decision block 940, it may be determined whether the monitoring is complete. If the monitoring is complete, then method 900 may end at end block 950. If the monitoring is not complete, method 900 may return to block 920 for continued monitoring of the measurement device.

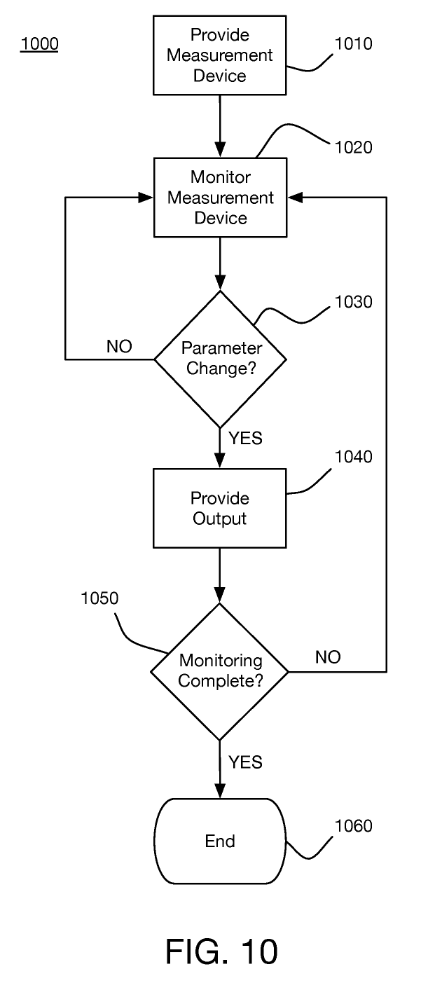

Referring now to FIG. 10, a method 1000 according to another embodiment is illustrated. Method 1000 may provide for continuous or intermittent monitoring of a force or torque at nanoscale and output when a change has been detected. At block 1010, a measurement device may be provided. Any measurement device as discussed herein may be provided. At block 1020, the measurement device may be monitored, for example using electrical probing by a sensing device or optical probing by a light source and a detector, as discussed. At decision block 1030, it may be determined whether there has been a change in the device such that one or more measurement parameters have changed. Whether a change has been detected may be based on a threshold value such that if the parameter change is greater than a threshold, an output may be provided at block 1040. The output may include a raw electrical signal, raw data, or correlated force or torque data. If the threshold is not met, no output may be provided and method 1000 may return to block 1020 and the measurement device may be monitored. After providing an output, at decision block 1050, it may be determined whether the monitoring is complete. If the monitoring is complete, then method 1000 may end at end block 1060. If the monitoring is not complete, method 1000 may return to block 1020 for continued monitoring of the measurement device.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A nanoscale measurement apparatus comprising:
a first plurality of nanoparticles coupled to a surface of a first substrate and configured to provide electrical continuity among the first plurality of nanoparticles;
a second plurality of nanoparticles coupled to a second surface of a second substrate and configured to provide electrical continuity among the second plurality of nanoparticles;
a pillar disposed between the surface of the first substrate and the second surface of the second substrate, and configured to separate the first plurality of nanoparticles from the second plurality of nanoparticles;
a first electrode coupled to the first plurality of nanoparticles;
a second electrode coupled to the second plurality of nanoparticles; and
a sensing device coupled to the first electrode and the second electrode, and configured to monitor an electrical characteristic.

2. The nanoscale measurement apparatus of claim 1, further comprising:
a second pillar disposed between the surface of the first substrate and the second surface of the second substrate, wherein the first pillar and the second pillar are disposed at a periphery of the first plurality of nanoparticles, and wherein the first pillar and the second pillar are rigid.

3. The nanoscale measurement apparatus of claim 1, wherein the pillar is disposed substantially at the center of the nanoscale measurement apparatus and among the first plurality of nanoparticles.

4. The nanoscale measurement apparatus of claim 1, wherein the sensing device includes a voltage source and a current measuring device.

5. The nanoscale measurement apparatus of claim 4, further comprising:
a third electrode coupled to the first plurality of nanoparticles; and
a fourth electrode coupled to the second plurality of nanoparticles, wherein the first electrode and the second electrode are disposed on one end of the nanoscale measurement apparatus and coupled to a first side of the voltage source.

6. The nanoscale measurement apparatus of claim 4, wherein the sensing device includes a processor and a memory, and wherein the sensing device is configured to provide correlated force data.

7. The nanoscale measurement apparatus of claim 4, further comprising:
a third electrode coupled to the first plurality of nanoparticles and the second plurality of nanoparticles.

8. The nanoscale measurement apparatus of claim 1, wherein the first plurality of nanoparticles are coupled to the surface of the first substrate by a plurality of couplers.

9. The nanoscale measurement apparatus of claim 1, further comprising:
a sealant disposed between the surface of the first substrate and the second surface of the second substrate and around an edge of the nanoscale measurement apparatus.

10. The nanoscale measurement apparatus of claim 1, wherein the first plurality of nanoparticles includes at least one of copper, silver, gold, nickel, palladium, platinum, tin, lead, or aluminum.

11. The nanoscale measurement apparatus of claim 1, wherein the first plurality of nanoparticles are arranged with a gap between at least two nanoparticles and wherein the gap is configured to be tunneled by electrons.

12. The nanoscale measurement apparatus of claim 1, wherein the first plurality of nanoparticles define a first mesh of nanoparticles and a second mesh of nanoparticles, the first mesh of nanoparticles and the second mesh of nanoparticles being in parallel electrically.

13. The nanoscale measurement apparatus of claim 1, wherein the first plurality of nanoparticles are configured to splay upon application of a force to one end of the first substrate, and the second plurality of nanoparticles are configured to compact upon application of the force.

14. The nanoscale measurement apparatus of claim 1, wherein the first plurality of nanoparticles and the second plurality of nanoparticles are configured to make physical contact upon the application of a force to one end of the first substrate.

15. A method comprising:
providing a nanoscale measurement device including a first plurality of nanoparticles coupled to a first substrate and separated from a second plurality of nanoparticles coupled to a second substrate by a pillar disposed between the first substrate and the second substrate;
securing a first portion of the nanoscale measurement device;
electrically probing the nanoscale measurement device to determine an electrical characteristic related to a force on a second portion of the nanoscale measurement device; and
correlating the electrical characteristic to a parameter measurement.

16. The method of claim 15, wherein the parameter measurement comprises at least one of a force measurement, a torque measurement, or an acceleration measurement.

17. The method of claim 15, wherein the first portion of the nanoscale measurement device is a first end of the nanoscale measurement device and the second portion of the nanoscale measurement device is another end of the nanoscale measurement device.

18. The method of claim 15, wherein the electrically probing the nanoscale measurement device comprises electrically probing the nanoscale measurement device with a sensing device that includes a voltage supply and a current sensor, and wherein the electrical characteristic is a resistance.

19. The method of claim 18, wherein the correlating the electrical characteristic comprises correlating the electrical characteristic with a processor and a memory of the sensing device.

20. The method of claim 18, wherein the correlating the electrical characteristic comprises correlating the electrical characteristic with a second device including a processor and a memory, and wherein the second device receives a raw electrical signal from the sensing device.

21. A system comprising:
a nanoscale measurement device including:
a first plurality of nanoparticles coupled to a surface of a first substrate and configured to provide electrical continuity among the first plurality of nanoparticles;
a second plurality of nanoparticles coupled to a second surface of a second substrate and configured to provide electrical continuity among the second plurality of nanoparticles;
a pillar disposed between the surface of the first substrate and the second surface of the second substrate, and configured to separate the first plurality of nanoparticles from the second plurality of nanoparticles;
a first electrode coupled to the first plurality of nanoparticles;
a second electrode coupled to the first plurality of nanoparticles;
a third electrode coupled to the second plurality of nanoparticles;
a fourth electrode coupled to the second plurality of nanoparticles;
a sensing device coupled to the first electrode, the second electrode, the third electrode, and the fourth electrode; and
a device coupled to the sensing device to receive a signal.

22. The system of claim 21, wherein the signal comprises a raw electrical signal and the device is configured to correlate the raw electrical signal to a force measurement.

23. The system of claim 21, wherein the sensing device includes a voltage source, and wherein the first electrode and the third electrode are coupled to a first side of the voltage source and the second electrode and the fourth electrode are coupled to a second side of the voltage source.

24. The system of claim 23, wherein the sensing device includes a processor and a memory, and the signal includes a force measurement.

25. The system of claim 21, wherein the nanoscale measurement device and the sensing device are secured to a mounting substrate, and the device is coupled to the sensing device through a pin connection.

26. A nanoscale measurement apparatus comprising:
a first plurality of nanoparticles coupled to a surface of a first substrate;
a second plurality of nanoparticles coupled to a second surface of a second substrate;
a pillar disposed between the surface of the first substrate and the second surface of the second substrate, and configured to separate the first plurality of nanoparticles from the second plurality of nanoparticles;
a light source configured to irradiate light rays onto the apparatus; and
a detector configured to detect a change in an optical property of the device by monitoring a resultant light ray.

27. The nanoscale measurement apparatus of claim 26, wherein the detector is configured to detect at least one of a polarization change, an optical intensity change, or a diffraction pattern.

28. The nanoscale measurement apparatus of claim 26, wherein the light source and the detector are configured to pass the light rays through the first substrate, the first plurality of nanoparticles, the second plurality of nanoparticles, and the second substrate.

29. The nanoscale measurement apparatus of claim 26, wherein the first substrate is at least partially transparent, and wherein the light source and the detector are configured to deflect the light rays off the first plurality of nanoparticles.

30. The nanoscale measurement apparatus of claim 26, wherein the light source and the detector are configured to pass light rays along an axis substantially planar to the first plurality of nanoparticles.

31. The nanoscale measurement apparatus of claim 26, further comprising:
a first electrode coupled to the first plurality of nanoparticles;
a second electrode coupled to the second plurality of nanoparticles; and
a sensing device coupled to the first electrode and the second electrode, and configured to monitor an electrical characteristic.
